(19) United States
(12) Patent Application Publication
(10) Pub. No.: US 2025/0164725 A1
(43) Pub. Date: May 22, 2025

(54) LOOSE TUBE AND OPTICAL CABLE HAVING THE SAME

(71) Applicant: Jiangsu Zhongtian Technology Co., Ltd., Jiangsu (CN)

(72) Inventors: Jing ZHAO, Jiangsu (CN); Jianqiu XU, Jiangsu (CN); Xinmin MA, Jiangsu (CN); Huihui QIAN, Jiangsu (CN); Weiwei MIAO, Jiangsu (CN); Xiaoming MIAO, Jiangsu (CN); Feng TAN, Jiangsu (CN)

(73) Assignee: Jiangsu Zhongtian Technology Co., Ltd., Jiangsu (CN)

(21) Appl. No.: 19/026,678

(22) Filed: Jan. 17, 2025

Related U.S. Application Data
(63) Continuation of application No. PCT/CN2024/073902, filed on Jan. 24, 2024.

(30) Foreign Application Priority Data
Nov. 21, 2023 (CN) 202311557376.8

(51) Int. Cl. G02B 6/44

(52) U.S. Cl. CPC G02B 6/443

(57) ABSTRACT

The present application provides a loose tube and an optical cable having the same. The loose tube includes: a central portion including a first filler and a plurality of first optical units arranged within the first filler; an inner coating layer sleeved on the outer sidewall of the central portion; an intermediate layer sleeved on the outer sidewall of the inner coating layer, the intermediate layer including a second filler and a plurality of second optical units arranged within the second filler; an outer coating layer sleeved on the outer sidewall of the intermediate layer; and a separating portion arranged on the inner coating layer or within the intermediate layer and dividing the plurality of second optical units into a plurality of optical unit groups.

### CROSS-REFERENCE TO RELATED APPLICATION

This application is a continuation of International Application No. PCT/CN2024/073902, filed on Jan. 24, 2024, which claims priority to Chinese Patent Application No. 202311557376.8, filed on Nov. 21, 2023. The disclosures of the aforementioned applications are hereby incorporated by reference in their entireties.

### BACKGROUND

### Technical Field

The present application relates to the technical field of optical cable communication. Specifically, it relates to a loose tube and an optical cable having the same.

### Description of Related Art

A central-tube optical cable, which consists of a central bundled-tube, fillers, reinforcements and a sheath, is suitable for laying scenarios such as pipelines, direct burial laying and overhead laying. Among them, the central bundled-tube is the most important part of the optical cable. The optical fibers are arranged in bundles through the central bundled-tube, which can reduce the diameter of the optical cable, lower the requirements for pipeline space, and improve the utilization of routing resources; and at the same time, it is relatively lighter in weight and easier for laying.

In the related technology, when the number of optical fiber cores in the loose tube exceeds 24 cores, colored threads of different colors are used to wind and bind 12-core full-spectrum optical fibers into one bundle of optical unit, thereby facilitating distinction.

However, in the related technology, as the number of optical fiber cores continues to increase, there are more optical units which are formed by winding and binding of colored threads of different colors. When there are too many optical fibers, it will lead to the inability to identify the optical fibers when splicing them, thus affecting the splicing efficiency of the optical fibers.

### SUMMARY

The present application provides a loose tube and an optical cable having the same, so as to solve the problem in the related technology that as the number of optical units formed by winding and binding with colored threads of different colors increases, there are too many optical fibers, which will lead to the failure of identifying the optical fibers when splicing them, thus affecting the splicing efficiency of the optical fibers.

According to one aspect of the present application, a loose tube is provided, including a central portion including a first filler and a plurality of first optical units arranged within the first filler; an inner coating layer sleeved on the outer sidewall of the central portion; an intermediate layer sleeved on the outer sidewall of the inner coating layer, the intermediate layer including a second filler and a plurality of second optical units arranged within the second filler; an outer coating layer sleeved on the outer sidewall of the intermediate layer; and a separating portion arranged on the inner coating layer or within the intermediate layer, the separating portion dividing the plurality of second optical units into a plurality of optical unit groups.

Further, the separating portion includes a protrusion arranged at the outer surface of the inner coating layer, a groove is arranged at a position of the intermediate layer corresponding to the protrusion, and the protrusion protrudes into the groove.

Further, the separating portion includes a buffer post arranged within the protrusion, and the buffer post is made of an elastic material.

Further, the inner coating layer has a columnar outer surface, the intermediate layer has a columnar inner surface, and the columnar outer surface and the columnar inner surface are arranged in a closely fit manner; the separating portion includes a separating post arranged within the intermediate layer, and the separating post is made of an elastic material.

Further, each optical unit group includes a plurality of second optical units arranged in a radial direction.

Further, the central portion, the inner coating layer and the intermediate layer form an optical fiber column, a plurality of optical fiber columns are wrapped by the same outer coating layer, and a third filler is arranged between the plurality of optical fiber columns and the outer coating layer.

Further, the cross-sectional dimension of the protrusion is greater than one half of the cross-sectional dimension of the second optical unit.

Further, the hardness of the inner coating layer gradually increases in a direction from the central portion towards the outer coating layer, and the hardness of the outer coating layer is greater than that of the inner coating layer.

Further, the first filler, the second filler and the third filler are all filling fiber jelly, the viscosity of the third filler is greater than that of the second filler, and the viscosity of the second filler is greater than that of the first filler.

Further, both the inner coating layer and the outer coating layer are made of a plastic material.

Further, the loose tube includes a plurality of inner coating layers and a plurality of intermediate layers, the plurality of inner coating layers and the plurality of intermediate layers are arranged alternately, and the outer coating layer is sleeved on the outer sidewall of the outermost intermediate layer.

According to another aspect of the present application, an optical cable is provided, including: a loose tube; an armor layer sleeved on the outer sidewall of the loose tube; and a protective layer sleeved on the outer sidewall of the armor layer, where the loose tube is the loose tube provided above.

According to the technical solution of the present application, the loose tube includes a central portion, an inner coating layer, an intermediate layer, an outer coating layer and a separating portion, where the central portion is composed of a first filler and a plurality of first optical units. Specifically, by arranging the plurality of first optical units within the first filler, the first filler can then play a fixing role for the plurality of first optical units; by sleeving the inner coating layer on the outer sidewall of the central portion, the inner coating layer can play a supporting role for the central portion, and the intermediate layer is sleeved on the outer side wall of the inner coating layer. The intermediate layer includes the second filler and a plurality of second optical units, and the outer coating layer is sleeved on the outer sidewall of the intermediate layer, so that the intermediate layer is disposed between the inner coating layer and the outer coating layer, that is, the plurality of second optical units are fixed by the second filler. The separating portion is disposed within the inner coating layer or the intermediate layer, and the plurality of second optical units are divided into a plurality of optical unit groups by the separating portion. By setting the separating portion, the plurality of second optical units in the intermediate layer can be separated, thereby facilitating the identification of the plurality of second optical units and ensuring the splicing efficiency of the optical fibers.

### BRIEF DESCRIPTION OF THE DRAWINGS

The drawings in the specification, which form a part of this application, are used to provide a further understanding of the present application, and the exemplary embodiments of the present application and their descriptions are used to explain the present application and do not constitute improper limitations on the present application. In the drawings:

FIG. 1 shows a schematic diagram of a loose tube according to an embodiment of the present application;

FIG. 2 shows a schematic diagram of a loose tube according to another embodiment of the present application;

FIG. 3 shows a schematic diagram of a loose tube according to yet another embodiment of the present application;

FIG. 4 shows a schematic diagram of a loose tube according to still another embodiment of the present application;

FIG. 5 shows a schematic diagram of an optical cable according to an embodiment of the present application.

Among them, the above drawings include the following reference numerals: 10: central portion; 11: first filler; 12: first optical unit; 20: inner coating layer; 30: intermediate layer; 31: second filler; 32: second optical unit; 33: groove; 34: optical unit group; 40: outer coating layer; 50: separating portion; 51: protrusion; 52: buffer post; 53: separating post; 61: optical fiber column; 62: third filler; 71: loose tube; 72: armor layer; 73: protective layer.

### DESCRIPTION OF THE EMBODIMENTS

The following will clearly and completely describe the technical solutions in the embodiments of the present application in combination with the drawings in the embodiments of the present application, obviously, the described embodiments are only a part of the embodiments of the present application, rather than all of them. The following description of at least one exemplary embodiment is merely illustrative in fact and is in no way intended to limit the application, its application, or uses. Based on the embodiments of the present application, all other embodiments obtained by persons of ordinary skill in the art without creative efforts fall within the protection scope of the present application.

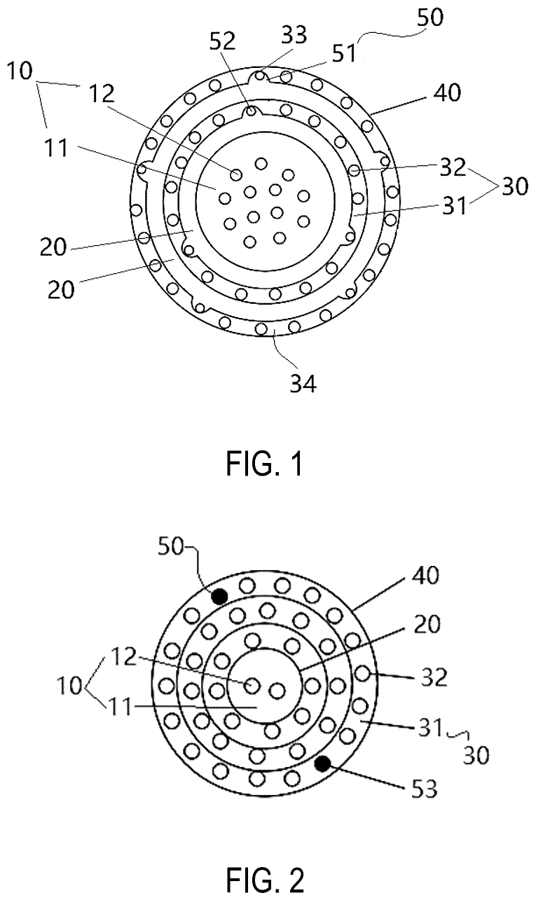

As shown in FIGS. 1 to 4, an embodiment of the present application provides a loose tube, which includes a central portion 10, an inner coating layer 20, an intermediate layer 30, an outer coating layer 40 and a separating portion 50. The central portion 10 includes a first filler 11 and a plurality of first optical units 12 arranged within the first filler 11; the inner coating layer 20 is sleeved on the outer sidewall of the central portion 10; the intermediate layer 30 is sleeved on the outer sidewall of the inner coating layer 20; the intermediate layer 30 includes a second filler 31 and a plurality of second optical units 32 arranged within the second filler 31; the outer coating layer 40 is sleeved on the outer sidewall of the intermediate layer 30; the separating portion 50 is arranged on the inner coating layer 20 or within the intermediate layer 30, and the separating portion 50 divides the plurality of second optical units 32 into a plurality of optical unit groups 34.

The loose tube provided by the present embodiment is applied, and the loose tube includes the central portion 10, inner coating layers 20, intermediate layers 30, the outer coating layer 40 and separating portions 50. The central portion 10 is composed of the first filler 11 and a plurality of first optical units 12. Specifically, by arranging the plurality of first optical units 12 within the first filler 11, the first filler 11 can play a fixing role in the plurality of first optical units 12; by sleeving the inner coating layer 20 on the outer sidewall of the central portion 10, the inner coating layer 20 can play a supporting role for the central portion 10; by sleeving the intermediate layer 30 on the outer sidewall of the inner coating layer 20, the intermediate layer 30 includes the second filler 31 and a plurality of second optical units 32, and the outer coating layer 40 is sleeved on the outer sidewall of the intermediate layer 30, so that the intermediate layer 30 is arranged between the inner coating layer 20 and the outer coating layer 40, that is, the plurality of second optical units 32 are fixed by the second filler 31. The separating portion 50 is arranged within the inner coating layer 20 or the intermediate layer 30, and is configured to divide the plurality of second optical units 32 into a plurality of optical unit groups 34. By setting the separating portion 50, the plurality of second optical units 32 in the intermediate layer 30 can be separated, thereby facilitating the identification of the plurality of second optical units 32 and ensuring the splicing efficiency of the optical fibers.

As shown in FIG. 1, the separating portion 50 includes a protrusion 51 arranged at the outer surface of the inner coating layer 20, and a groove 33 is arranged at the position of the intermediate layer 30 corresponding to the protrusion 51, with the protrusion 51 protruding into the groove 33. With the above structure, by arranging the protrusion 51 at the outer surface of the inner coating layer 20 and arranging the groove 33 at the position of the intermediate layer 30 corresponding to the protrusion 51, it is convenient to use the protrusion to play a supporting role for the intermediate layer 30. Moreover, by using the cooperation between the protrusion 51 and the groove 33, it is possible to use the groove 33 to separate the plurality of second optical units 32 in the intermediate layer 30, thereby facilitating using the groove 33 to identify the second optical units 32 in the intermediate layer 30 and facilitating the splicing of the optical fibers.

As shown in FIG. 1, the separating portion 50 includes a buffer post 52 arranged within the protrusion 51, and the buffer post 52 is made of an elastic material. With the above structure, by arranging the buffer post 52 within the protrusion 51, the buffer post 52 can play a cushioning effect on the inner coating layer 20 and the buffer post 52 can resist compressive deformation.

It should be noted that in the present embodiment, the elastic material is TPE (Thermoplastic Elastomer), which is either artificial rubber or synthetic rubber. In other embodiments, the buffer post 52 may be one of TPU (Thermoplastic Polyurethane), TPV (Thermoplastic Vulcanizate), TPO (Thermoplastic Olefin) and TPEE (Thermoplastic Polyester Elastomer).

It should be noted that the buffer post 52 can be distinguished by different colors.

Among them, the hardness of the buffer post 52 is set to be between 25D (Shore D scale) and 60D, so that the buffer post 52 has better flexibility and elasticity and thus is able to resist compressive deformation.

Specifically, the hardness of the buffer post 52 may be set to 25D, 30D, 35D, 40D, 45D, 50D, 55D, 60D, or any other value between 25D and 60D.

As shown in FIG. 2, the inner coating layer 20 has a columnar outer surface, the intermediate layer 30 has a columnar inner surface, and the columnar outer surface and the columnar inner surface are arranged in a closely fit manner; the separating portion 50 includes a separating post 53 arranged within the intermediate layer 30, and the separating post 53 is made of an elastic material. With the above structure, by making the columnar inner surface of the intermediate layer 30 fit closely with the columnar outer surface of the inner coating layer 20 and arranging the separating post 53 within the intermediate layer 30, the separating posts 53 can play a role in separating the plurality of second optical units 32, which facilitates the identification of the second optical units, and the use of the separating post 53 can also provide a support and buffering for the intermediate layer 30.

It should be noted that the outer coating layer 40 and the inner coating layer 20 have different thicknesses. The thickness of the outer coating layer 40 is set to be between 0.4 mm and 1 mm, while the thickness of the inner coating layer 20 is set to be between 0.1 mm and 0.3 mm. The outer coating layer 40 mainly plays a role in withstanding external forces and protecting the inner coating layer 20 and the intermediate layer 30. The inner coating layer 20 has a relatively small thickness, which facilitates the realization of the function of multi-layer filling within the multi-layer structure composed of the inner coating layer 20, the intermediate layer 30 and the outer coating layer 40.

In this embodiment, the elastic material is TPE, which is either artificial rubber or synthetic rubber. In other embodiments, the separating post 53 may be one of TPU, TPV, TPO and TPEE.

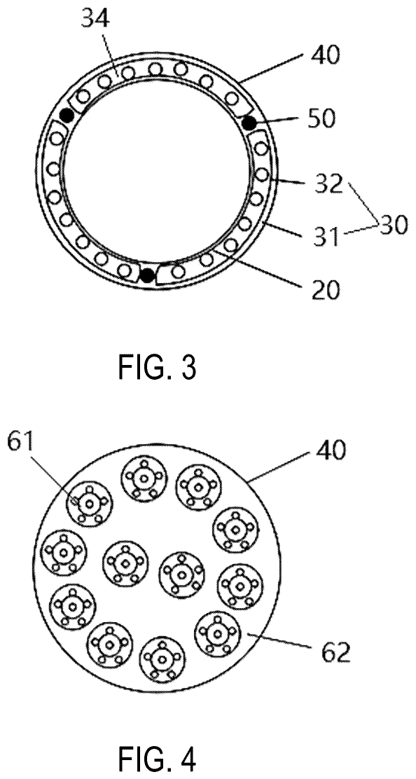

As shown in FIG. 3, each optical unit group 34 includes a plurality of second optical units 32 arranged in a radial direction. With the above structure, by connecting the plurality of second optical units 32 in each optical unit group 34 through a connecting piece, it is convenient to fix the optical unit group 34 through the second filler 31, which facilitates the identification of the optical unit group 34. In this way, it is convenient to assemble the optical unit group 34 and identify the second optical units 32 of the optical unit group 34, ensuring that the replacement operation is convenient.

It should be noted that the plurality of second optical units 32 are arranged. After the plurality of second optical units 32 are arranged and fixed, they are fixed by the second filler 31. Moreover, respective optical unit groups 34 are separated each other by the buffer post 52, which enables the identification of the optical unit groups 34.

As shown in FIG. 4, the central portion 10, the inner coating layer 20 and the intermediate layer 30 form an optical fiber column 61. A plurality of optical fiber columns 61 are wrapped by the same outer coating layer 40, and a third filler 62 is arranged between the plurality of optical fiber columns 61 and the outer coating layer 40. With the above structure, by forming the optical fiber column 61 with the central portion 10, the inner coating layer 20 and the intermediate layer 30, the outer coating layer 40 wraps the plurality of optical fiber columns 61 and the plurality of optical fiber columns 61 are filled with the third filler 62, which is convenient to use the outer coating layer 40 to wrap the plurality of optical fiber columns 61.

In this embodiment, the cross-sectional dimension of the protrusion 51 is greater than one half of the cross-sectional dimension of the second optical unit 32. With the above structure, by making the cross-sectional dimension of the protrusion 51 greater than one half of the cross-sectional dimension of the second optical unit 32, it is convenient to use the protrusion 51 to play a role in separating the second optical units 32. In this way, it can not only play a supporting role for the intermediate layer 30, but also facilitate the identification of the plurality of second optical units 32.

In this embodiment, the hardness of the inner coating layer 20 gradually increases in a direction from the central portion 10 towards the outer coating layer 40, and the hardness of the outer coating layer 40 is greater than that of the inner coating layer 20. With the above structure, by setting the hardness of the inner coating layer 20 to increase gradually in the direction from the central portion 10 towards the outer coating layer 40, damage to the inner coating layer 20 can be avoided. Moreover, since the hardness of the outer coating layer 40 is greater than that of the inner coating layer 20, it can ensure the protection of the first optical units 12 within the inner coating layer 20 and the second optical units 32 within the intermediate layer 30, and enhance the compressive and tensile strengths of the outer coating layer 40. Furthermore, the hardness of the inner coating layer 20 is less than that of the outer coating layer 40, which makes the inner coating layer 20 more flexible, improves its anti-bending performance, facilitates the release of its own stress, and then realizes its filling.

It should be noted that the hardness of adjacent inner coating layers 20 is different. The hardness ranges of both the inner coating layer 20 and the outer coating layer 40 are set to be between 25D and 85D, and the hardness gradually increases in the direction from the central portion 10 towards the outer coating layer 40, so that the inner coating layer 20 sleeved on the central portion 10 has the smallest hardness, and the inner coating layer 20 sleeved on the central portion 10 has a hardness between 25D and 35D. The outermost outer coating layer 40 has the largest hardness, and the hardness of the outer coating layer 40 is set to be between 75D and 85D. The inner coating layer 20 disposed between the inner coating layer 20 sleeved on the central portion 10 and the outer coating layer 40 has a hardness between 35D and 75D, so that the smaller the hardness is, the better the flexibility and anti-bending performance will be, which is more convenient to release its own stress and facilitate the filling of multiple inner coating layers 20; and when the hardness of the inner coating layer 20 is greater, its resistance to lateral compression and tensile strength will be higher.

Among them, the hardness of the inner coating layer 20 sleeved on the central portion 10 may be set to 25D, 30D, 35D or any other value between 25D and 35D; the hardness of the outer coating layer 40 may be set to 75D, 80D, 85D or any other value between 75D and 85D; the hardness of the inner coating layer 20 disposed between the inner coating layer 20 sleeved on the central portion 10 and the outer coating layer 40 may be set to 35D, 40D, 45D, 50D, 55D, 60D, 65D, 70D, 75D or any other value between 35D and 75D.

Specifically, each inner coating layer 20 can be identified by color, which facilitates the identification of optical fibers.

In this embodiment, the first filler 11, the second filler 31 and the third filler 62 are all filling fiber jelly. The viscosity of the third filler 62 is greater than that of the second filler 31, and the viscosity of the second filler 31 is greater than that of the first filler 11. By the fact that the viscosity of the third filler 62 is greater than that of the second filler 31 and the viscosity of the second filler 31 is greater than that of the first filler 11, the multi-layer structure of the loose tube can be ensured to be stable, avoiding the detachment of the outer coating layer 40, the intermediate layer 30 or the inner coating layer 20, and also playing a role in water blocking.

It should be noted that since adjacent inner coating layers 20 do not come into contact with each other, as the number of layers of the intermediate layer 30 and the inner coating layer 20 gradually increases, when the optical cable is vertically suspended, different viscosities are set accordingly in order to avoid the overflow of the inner coating layer 20, the filled second optical units 32 and the second filler. In this way, the overflow of the inner coating layer 20, the filled second optical units 32 and the second filler can be reduced, and the service life of the optical cable can be extended.

The viscosity of the first filler 11 within the central portion 10 is set to be between 2000 mPa·s and 3000 mPa·s. The viscosity of the second filler 31 disposed between two adjacent inner coating layers 20 is set to be between 3000 mPa·s and 4500 mPa·s. The viscosity of the third filler 62 close to the outer coating layer 40 is set to be between 4500 mPa·s and 6000 mPa·s.

Specifically, the viscosity of the first filler within the central portion 10 can be set to 2200 mPa·s, 2400 mPa·s, 2600 mPa·s, 2800 mPa·s, 3000 mPa·s or any other value between 2000 mPa·s and 3000 mPa·s; the viscosity of the second filler between two adjacent inner coating layers 20 can be set to 3000 mPa·s, 3300 mPa·s, 3600 mPa·s, 3900 mPa·s, 4200 mPa·s, 4500 mPa·s or any other value between 3000 mPa·s and 4500 mPa·s; the viscosity of the third filler close to the outer coating layer 40 can be set to 4500 mPa·s, 5000 mPa·s, 5500 mPa·s, 6000 mPa·s or any other value between 4500 mPa·s and 6000 mPa·s.

In this embodiment, both the inner coating layer 20 and the outer coating layer 40 are made of plastic materials. With the above structure, it is convenient to conduct production and processing on the inner coating layer 20 and the outer coating layer 40.

It should be noted that in other embodiments, the materials of the inner coating layer 20 and the outer coating layer 40 may be one of PP (Polypropylene), PBT (Polybutylene Terephthalate), and TPEE.

As shown in FIGS. 1 to 4, the loose tube includes a plurality of inner coating layers 20 and a plurality of intermediate layers 30. The plurality of inner coating layers 20 and the plurality of intermediate layers 30 are arranged alternately, and the outer coating layer 40 is sleeved on the outer sidewall of the outermost intermediate layer 30. With the above structure, by setting the plurality of inner coating layers 20 and the plurality of intermediate layers 30, and arranging the plurality of inner coating layers 20 and the plurality of intermediate layers 30 alternately, it is possible to set a plurality of second optical units 32, which facilitates identification of optical units and formation of a multi-layer structure. Each inner coating layer 20 is identified by color, and the colors are different, which is beneficial for identifying the second optical units. Moreover, the number of the second optical units 32 gradually increases as the number of the intermediate layers 30 increases.

It should be noted that when the first optical units 12 or the second optical units 32 are being filled, they extend along the surface of the inner coating layer 20 and are spirally arranged at a certain angle with respect to the central portion 10, ensuring that there is a certain margin for the first optical units 12 or the second optical units 32, which is beneficial for the stability of the transmission performance of the optical cable.

Where, the relationship between the maximum total number of optical fibers F that can be accommodated in the loose tube, the number of coating layers n, the maximum number of optical fiber cores Q that can be accommodated in each layer, and the number of optical fiber cores m in the central portion is as follows: Q=2n−2*m, F=(2n−1−1)*m; where n≥3; 1≤m≤12.

It should be noted that during the manufacturing process of the loose tube, extrusion molding is carried out successively in a manner from the inside to the outside. That is to say, the innermost inner coating layer 20 is extruded and molded first, and then a plurality of inner coating layers 20 are extruded and molded in turn until the outer coating layer 40 is extruded and molded.

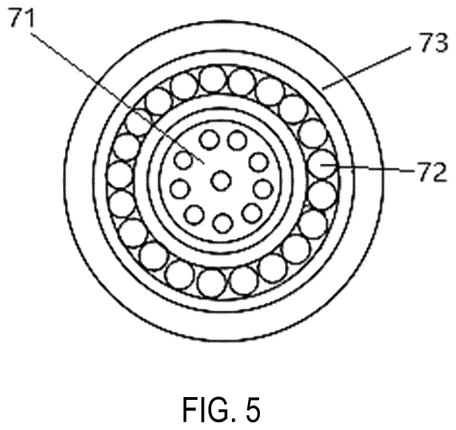

As shown in FIG. 5, another embodiment of the present application provides an optical cable. The optical cable includes a loose tube 71, an armor layer 72 and a protective layer 73. The armor layer 72 is sleeved on the outer sidewall of the loose tube 71, and the protective layer 73 is sleeved on the outer sidewall of the armor layer 72, and the loose tube 71 is the loose tube provided as above. With the above structure, the armor layer 72 can improve the tensile performance of the loose tube 71, and the protective layer 73 can play a protective role to ensure the structural stability of the optical cable.

It should be noted that the armor layer 72 includes an armor unit and a water-blocking filler. The armor unit is filled into the water-blocking filler, which can not only play a protective role for the loose tube 71 but also have a waterproof effect.

The device provided by this embodiment has the following beneficial effects.

(1) The outer coating layer 40 is sleeved on the outer sidewall of the intermediate layer 30, so that the intermediate layer 30 is arranged between the inner coating layer 20 and the outer coating layer 40, that is, the plurality of second optical units 32 are fixed by the second filler 31. The separating portion 50 is arranged within the inner coating layer 20 or the intermediate layer 30, and the separating portion 50 is used to divide the plurality of second optical units 32 into the plurality of optical unit groups 34. By setting the separating portion 50, the plurality of second optical units 32 in the intermediate layer 30 can be separated, thereby facilitating the identification of the plurality of second optical units 32 and ensuring the splicing efficiency of the optical fibers.

(2) By arranging the protrusion 51 on the outer surface of the inner coating layer 20 and arranging the groove 33 at the position of the intermediate layer 30 corresponding to the protrusion 51, it is convenient to use the protrusion to play a supporting role for the intermediate layer 30. Moreover, by using the cooperation between the protrusion 51 and the groove 33, it is possible to use the groove 33 to separate the plurality of second optical units 32 in the intermediate layer 30, thereby facilitating identification of the second optical units 32 in the intermediate layer 30 using the groove 33 and facilitating the splicing of the optical fibers.

(3) By setting the hardness of the inner coating layer 20 to increase gradually in a radial direction, damage to the inner coating layer 20 can be avoided. Moreover, the hardness of the outer coating layer 40 is greater than that of the inner coating layer 20, ensuring that the first optical units 12 within the inner coating layer 20 and the second optical units 32 within the intermediate layer 30 can be protected, and enhancing the compressive and tensile strengths of the outer coating layer 40. And the hardness of the inner coating layer 20 is less than that of the outer coating layer 40, making the inner coating layer 20 more flexible, improving the anti-bending performance, facilitating the release of its own stress, and then realizing the filling.

It should be noted that the terms used herein are only for the purpose of describing specific embodiments and are not intended to limit the exemplary embodiments according to the present application. As used herein, unless the context clearly indicates otherwise, the singular form is also intended to include the plural form. In addition, it should also be understood that when the terms “comprise” and/or “include” are used in this specification, they indicate the presence of a feature, a step, an operation, a device, a component and/or combination thereof.

Unless otherwise specifically stated, the relative arrangements of components and steps, numerical expressions and values set forth in these embodiments do not limit the scope of the present application. Meanwhile, it should be understood that for the convenience of description, the dimensions of various parts shown in the drawings are not drawn in accordance with the actual proportional relationships. Technologies, methods and equipment known to persons of ordinary skill in the relevant fields may not be discussed in detail, but under appropriate circumstances, such technologies, methods and equipment should be regarded as part of the specification. In all the examples shown and discussed herein, any specific value should be interpreted as merely exemplary and not as a limitation. Therefore, other examples of the exemplary embodiments may have different values. It should be noted that similar reference numbers and letters denote similar items in the following drawings. Therefore, once an item is defined in one drawing, it does not need to be further discussed in subsequent drawings.

In the description of the present application, it should be understood that the orientation or positional relationships indicated by orientation words such as “front”, “back”, “up”, “down”, “left”, “right”, “lateral”, “vertical”, “perpendicular”, “horizontal” and “top”, “bottom”, etc. are usually based on the orientation or positional relationships shown in the drawings. They are merely for the convenience of describing the present application and simplifying the description. Unless otherwise stated, these orientation words do not indicate and imply that the referred device or element must have a specific orientation or be constructed and operated in a specific orientation. Therefore, they should not be construed as limitations on the protection scope of the present application. The orientation words “inside” and “outside” refer to the inside and outside relative to the contour of each component itself.

For the convenience of description, spatial relative terms such as “above . . . ”, over . . . “on the upper surface of . . . ”, “upper . . . ” and the like can be used herein to describe the spatial positional relationship between one device or feature and other device or feature as shown in the figures. It should be understood that the spatial relative terms are intended to encompass different orientations in use or operation in addition to the orientations of the devices described in the figures. For example, if the device in the drawing is inverted, a device described as “above other device or structure” or “over other device or structure” will then be positioned as “below other device or structure” or “under other device or structure” later. Thus, the exemplary term “above” can include both the orientations of “above” and “below”. The device can also be positioned in other different ways (being rotated by 90 degrees or in other orientations), and the spatially relative descriptions used herein are interpreted accordingly.

In addition, it should be noted that using words such as “first” and “second” to define parts and components is merely for the convenience of distinguishing the corresponding parts and components. Unless otherwise stated, these words have no special meanings and thus should not be understood as limitations on the protection scope of the present application.

The above descriptions are only preferred embodiments of the present application and are not intended to limit the present application. For persons of ordinary skill in the art, the present application may have various modifications and changes. Any modifications, equivalent replacements, improvements, etc. made within the spirit and principles of the present application shall be included within the protection scope of the present application.

What is claimed is:

1. A loose tube, wherein the loose tube comprises:
a central portion comprising a first filler and a plurality of first optical units arranged within the first filler;
an inner coating layer sleeved on an outer sidewall of the central portion;
an intermediate layer sleeved on an outer sidewall of the inner coating layer, the intermediate layer comprising a second filler and a plurality of second optical units arranged within the second filler;
an outer coating layer sleeved on an outer sidewall of the intermediate layer;
a separating portion arranged on the inner coating layer or within the intermediate layer, the separating portion dividing the plurality of second optical units into a plurality of optical unit groups.

2. The loose tube according to claim 1, wherein the separating portion comprises a protrusion arranged at an outer surface of the inner coating layer, a groove is arranged at a position of the intermediate layer corresponding to the protrusion, and the protrusion protrudes into the groove.

3. The loose tube according to claim 2, wherein the separating portion comprises a buffer post arranged within the protrusion, and the buffer post is made of an elastic material.

4. The loose tube according to claim 1, wherein the inner coating layer has a columnar outer surface, the intermediate layer has a columnar inner surface, and the columnar outer surface and the columnar inner surface are arranged in a closely fit manner; the separating portion comprises a separating post arranged within the intermediate layer, and the separating post is made of an elastic material.

5. The loose tube according to claim 1, wherein each of the optical unit groups comprises the plurality of second optical units arranged in a radial direction.

6. The loose tube according to claim 1, wherein the central portion, the inner coating layer and the intermediate layer form an optical fiber column; a plurality of optical fiber columns are wrapped by the same outer coating layer; and a third filler is arranged between the plurality of optical fiber columns and the outer coating layer.

7. The loose tube according to claim 2, wherein a cross-sectional dimension of the protrusion is greater than one half of a cross-sectional dimension of the second optical unit.

8. The loose tube according to claim 1, wherein a hardness of the inner coating layer gradually increases in a direction from the central portion towards the outer coating layer, and a hardness of the outer coating layer is greater than that of the inner coating layer.

9. The loose tube according to claim 6, wherein the first filler, the second filler and the third filler are all filling fiber jelly, a viscosity of the third filler is greater than that of the second filler, and the viscosity of the second filler is greater than that of the first filler.

10. The loose tube according to claim 1, wherein both the inner coating layer and the outer coating layer are made of plastic materials.

11. The loose tube according to claim 1, wherein the loose tube comprises a plurality of the inner coating layers and a plurality of the intermediate layers, the plurality of the inner coating layers and the plurality of the intermediate layers are arranged alternately, and the outer coating layer is sleeved on an outer sidewall of the outermost intermediate layer.

12. The loose tube according to claim 2, wherein the loose tube comprises a plurality of the inner coating layers and a plurality of the intermediate layers, the plurality of the inner coating layers and the plurality of the intermediate layers are arranged alternately, and the outer coating layer is sleeved on an outer sidewall of the outermost intermediate layer.

13. The loose tube according to claim 3, wherein the loose tube comprises a plurality of the inner coating layers and a plurality of the intermediate layers, the plurality of the inner coating layers and the plurality of the intermediate layers are arranged alternately, and the outer coating layer is sleeved on an outer sidewall of the outermost intermediate layer.

14. The loose tube according to claim 1, wherein the outer coating layer and the inner coating layer have different thicknesses.

15. An optical cable, wherein the optical cable comprises:
a loose tube;
an armor layer sleeved on an outer sidewall of the loose tube;
a protective layer sleeved on an outer sidewall of the armor layer, the loose tube being the loose tube according to claim 1.

16. The optical cable according to claim 15, wherein the separating portion comprises a protrusion arranged at an outer surface of the inner coating layer, a groove is arranged at a position of the intermediate layer corresponding to the protrusion, and the protrusion protrudes into the groove.

17. The optical cable according to claim 16, wherein the separating portion comprises a buffer post arranged within the protrusion, and the buffer post is made of an elastic material.
